(19) United States
(12) Patent Application Publication
(10) Pub. No.: US 2008/0141052 A1
(43) Pub. Date: Jun. 12, 2008

(54) System and method for detecting battery removal

(76) Inventors: Carl Thelemann, East Islip, NY (US); David Lundquist, Stony Brook, NY (US); Darren Kropp, Moriches, NY (US)

Correspondence Address: FAY KAPLUN & MARCIN, LLP, 150 BROADWAY, SUITE 702, NEW YORK, NY, 10038, US

(21) Appl. No.: 11/637,476

(22) Filed: Dec. 11, 2006

(51) Int. Cl. G06F 1/26; G06F 1/30

(52) U.S. Cl. 713/330; 713/300

(57) ABSTRACT

A device having a plurality of contact points providing connectivity between the device and a further device, a detection point providing connectivity between the device and the further device, wherein, as the further device is disconnected from the device, the detection point is disconnected prior to at least a portion of the plurality of contact points and a processor detecting the disconnection of the detection point and performing an action related to the detection of the disconnection.

### FIELD OF THE INVENTION

The present invention relates generally to a system and method for detecting the removal of a battery. Specifically, electrical contact points to connect the battery to a mobile unit include a detection point to alert the mobile unit that the battery will be removed.

### BACKGROUND

Portable devices often utilize a removable power source (e.g., battery) to provide the necessary energy to operate the device. The power source establishes an electrical connection to the device to supply the energy. The electrical connection may be established using, for example, a plurality of electrical contact points (e.g., pins) present on the device that couples to a corresponding plurality of electrical contact points on the power source. Often, users properly shut down the device prior to removal of the battery. However, in some instances the portable nature of the device causes the battery to be inadvertently removed. In addition, a user may also purposely remove the battery without properly shutting the device down. The improper removal of the battery may cause data to become lost or corrupted. Though some portable devices incorporate a back-up power supply, an abrupt removal of a battery creates a gap in the supplying of power.

### SUMMARY OF THE INVENTION

A device having a plurality of contact points providing connectivity between the device and a further device, a detection point providing connectivity between the device and the further device, wherein, as the further device is disconnected from the device, the detection point is disconnected prior to at least a portion of the plurality of contact points and a processor detecting the disconnection of the detection point and performing an action related to the detection of the disconnection.

A method for detecting whether a detection point of a device has been disconnected from a further device, wherein the detection point disconnects prior to a connection point between the device and a further device, determining whether the device is prepared for the disconnection of the further device and preparing the device for the disconnection.

A connector for a device having a plurality of contact points configured to couple to corresponding further contact points of a further connector and a detection point configured to couple to a corresponding detection point of a further connector, the detection point being configured to decouple from the corresponding detection point prior to at least a portion of the contact points decoupling from the corresponding further contact points.

### DESCRIPTION OF THE DRAWINGS

FIG. 1 shows a perspective view of a mobile device according to an exemplary embodiment of the present invention.

FIG. 2 shows a side view of the mobile device of FIG. 1.

FIG. 3 shows a perspective view of a battery according to an exemplary embodiment of the present invention.

FIG. 4 shows a side view of the battery of FIG. 3.

FIG. 5 shows a cross sectional view of an assembly of the mobile device of FIG. 1 with the battery of FIG. 3.

FIG. 6 shows a perspective view of contact points on the mobile device of FIG. 1.

FIG. 7a shows a cross sectional view of a first connection of the mobile device of FIG. 1 with the battery of FIG. 3.

FIG. 7b shows a cross sectional view of a second connection of the mobile device of FIG. 1 with the battery of FIG. 3.

FIG. 7c shows a cross sectional view of a fourth connection of the mobile device of FIG. 1 with the battery of FIG. 3.

FIG. 8 shows a first method of detecting battery removal according to an exemplary embodiment of the present invention.

FIG. 9 shows a second method of detecting battery removal according to an exemplary embodiment of the present invention.

### DETAILED DESCRIPTION

The present invention may be further understood with reference to the following description and the appended drawings, wherein like elements are referred to with the same reference numerals. The present invention describes a battery removal detection system that prevents loss or corruption of data. According to the exemplary embodiments of the present invention, a continuous power supply is provided to the mobile device until the device is placed in a condition where no loss or corruption of data may occur. Those skilled in the art will understand that there may be other adverse consequences from prematurely removing the battery from a mobile device and the exemplary embodiments will also prevent these other adverse consequences in addition to data corruption and/or loss.

In addition, the exemplary mobile device may include a back-up battery (e.g., a super-cap) when the primary battery is no longer available. However, the present invention may also apply to mobile devices without the back-up battery. The continuous supply of energy and the method to place the mobile device in a proper condition will be discussed in detail below.

Moreover as will be seen from the exemplary embodiments below, the detection of the battery removal may be based on detecting a state of a connector or connectors between the mobile device and the battery. Thus, the principles described herein may also be applicable to detecting the removal of any type of device from the mobile device and is not limited to batteries. Those skilled in the art will understand that the corresponding action taken with respect to the detection of a device that is not a battery may be different than those described herein, but the action will be related to the specific type of device that is being removed.

Conventional mobile devices with batteries may come equipped with safety mechanisms to prevent an improper removal of batteries. For example, a conventional mobile device may have a battery lock that holds the battery until proper steps are taken to shut down the mobile device or prevent a loss or corruption of data. When the proper steps are taken, the battery lock releases, thereby allowing a user to remove the battery. In another example, a latch system may be employed. In conventional mobile devices with a latch system, the user is required to activate (e.g., push toward each other) latches to remove the battery. The latch system may be two-fold. The release of a first latch signals the system to start shutting down. The release of a second latch actually releases the battery. It should be noted that there are other methods of battery removal that prevent improper removal. However, all these methods for conventional mobile devices require the user to perform additional steps so a loss or corruption of data do not occur. As will be discussed in more detail below, the present invention alleviates the problems associated with improper battery removal and removes the additional steps required to be taken by the user.

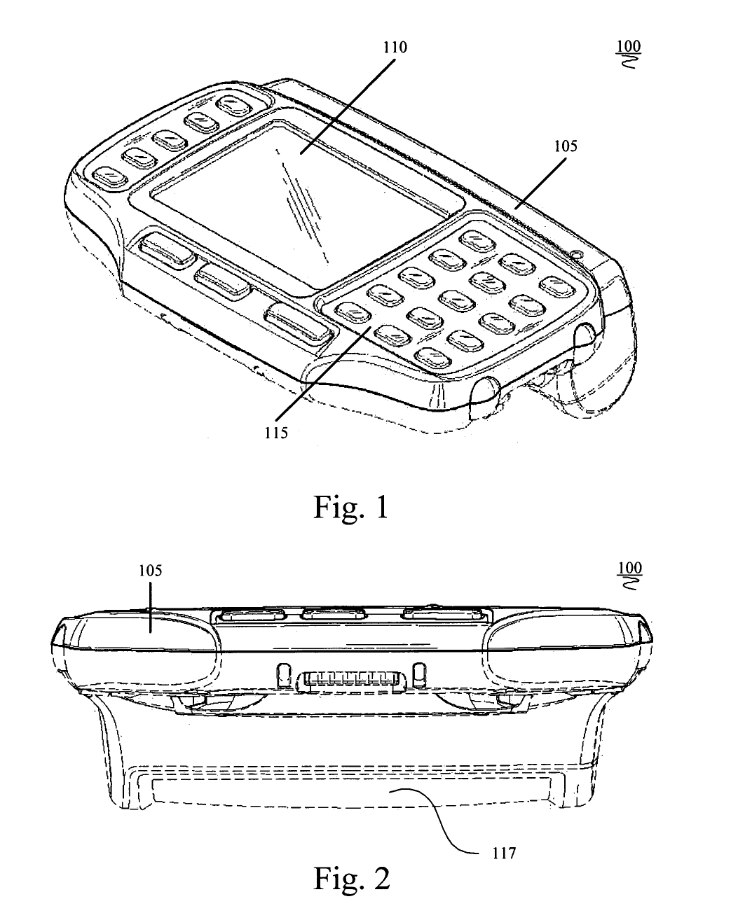

FIG. 1 shows a perspective view of a mobile device 100 according to an exemplary embodiment of the present invention. As illustrated in FIG. 1, the mobile device 100 may include, for example, a housing 105, a display 110, and an input device 115. The housing 105, display 110, and input device 115 may conform to conventional designs. It should be noted that the mobile device 100 may also include other components found in conventional mobile devices such as an illumination system, ports to accept other hardware devices, etc. The use of the present invention is not affected by the number or type of components. Other components such as those found within the mobile device (e.g., processor, printed circuit boards, wiring, etc.) (not shown) may also conform to conventional designs.

FIG. 2 shows a side view of the mobile device 100 of FIG. 1. As illustrated in FIG. 2, the housing 105 is shown. In this example, the battery is not currently connected to the mobile device 100. This side view shows a battery well 117 into which the battery may be inserted. As will be described in greater detail below, the battery well 117 includes a battery port to establish the electrical connection between the battery and the mobile device 100. It should be noted that the location of the battery well 117 and the corresponding battery port is only exemplary. Those skilled in the art will understand that the battery port may be located anywhere on a surface (e.g., bottom side, right side, left side, etc.) of the mobile device 100, in an accessible interior portion of the mobile device 100 or in a recess or well located in another location of the device 100.

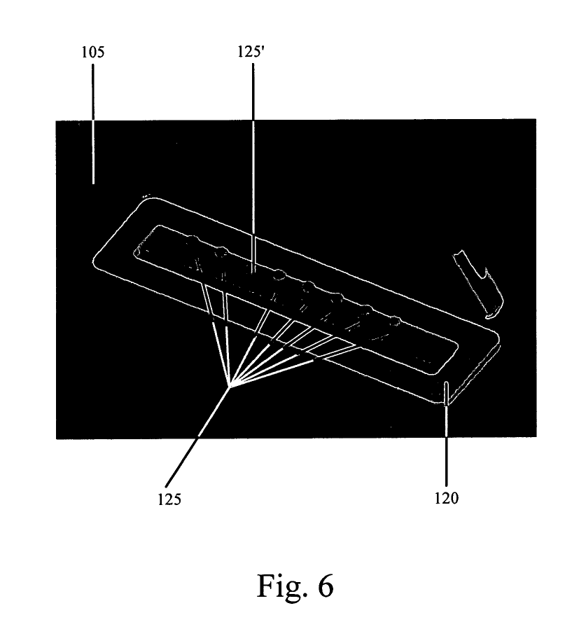

FIG. 6 shows a perspective view of the exemplary battery port 120 that may be included in the battery well 117 of FIG. 2, or as described above, in any location on the mobile device 100. The battery port 120 includes contact points 125 and having at least one detection point 125′. The term “detection point” is used herein to describe any type of connector that is disconnected prior to the remaining contact points when a battery is removed from the device 100. In the exemplary embodiments, the detection point 125′ is shorter than the remaining contact points 125. However, it is not required that the detection point be shorter than the other contact points, merely that it may be disconnected prior to the remaining contact points 125. For example, the detection point may be the same length as the remaining contact points, but the end may be made of a non-conducting material, thereby causing the detection point to disconnect prior to the remaining contact points. The disconnection of the detection point 125′ will be discussed in greater detail below.

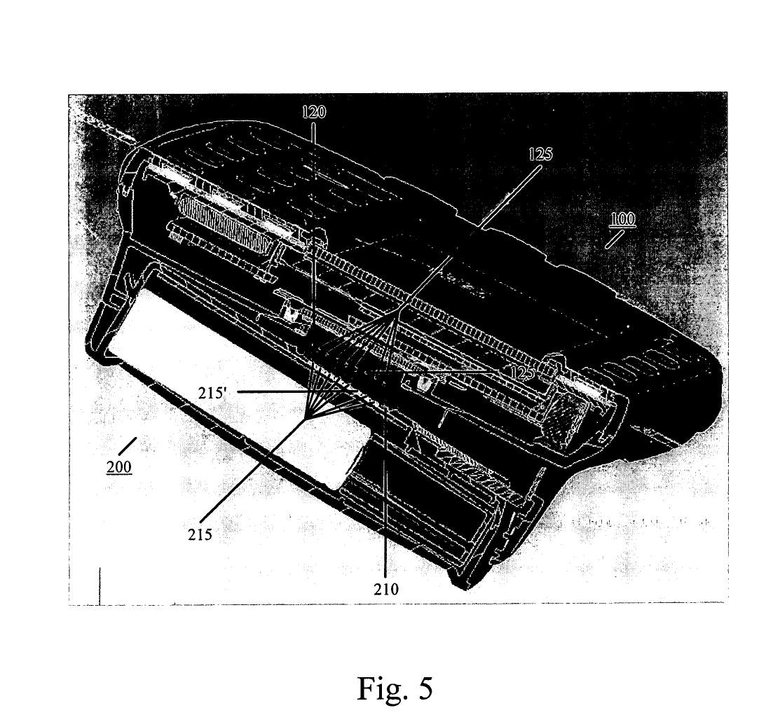

The battery port 120 is the site where a battery is connected to the mobile device 100. The contact points 125 provide the electrical connection between the battery and the mobile device 100. The contact points 125 may be, for example, solid pins, spring pins, metallic panels, etc. The detection point 125′ detects the removal of the battery. The detection point 125′ may be of the same type as the contact points 125. In addition, the detection point 125′ may be of a different type. For example, the contact points 125 may be solid pins while the detection point 125′ may be a spring pin. The battery port 120 may exhibit a frame that is used to facilitate the insertion of the battery. The frame of the battery port 120 may also, for example, extend beyond the surface of the housing 105. The contacts pins 125 and the detection point 125′ will be discussed in more detail below with further reference to FIG. 6 and FIGS. 5 and 7.

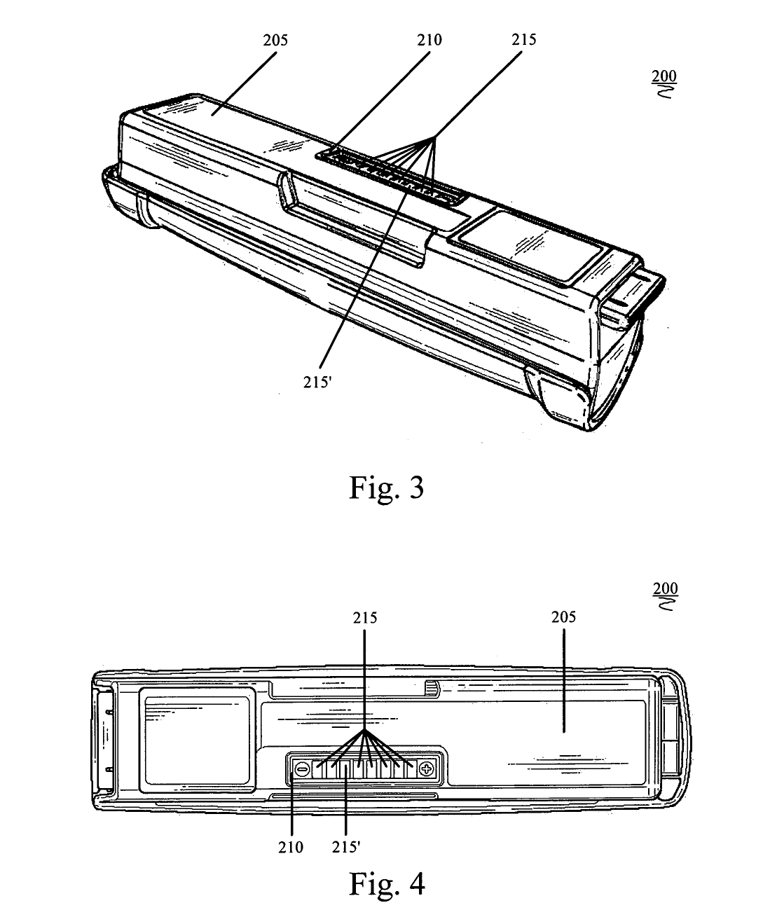

FIG. 3 shows a perspective view of a battery 200 according to an exemplary embodiment of the present invention. Specifically, the battery 200 corresponds to a battery that is coupled with the mobile device 100 of FIGS. 1-2. As illustrated in FIG. 3, the battery 200 may include, for example, a housing 205, a battery jack 210, corresponding points 215, and a corresponding detection point 215′. The housing 205 may conform to conventional designs. The internal circuitry (e.g., energy storage components, re-chargers, etc.) may also conform to conventional designs. The battery jack 210, the corresponding points 215, and the corresponding detection point 215′ will be discussed below with reference to FIG. 4.

It should be noted that the detection point 125′ of the mobile device 100 and the corresponding detection point 215′ of the battery 200 do not both need to be different from the remaining contact points 125 and 215, respectively. For example, it may be that the contact points 125 of the mobile device 100 are male pins having a first length. The detection point 125′ of the mobile device 100 may also be a male pin that has a length shorter than the first length. The contact points 215 of the battery 200 may be female connectors for receiving the male pins. The corresponding detection point 215′ may be the exact same female connector (i.e., same dimensions) as the contact points 215. Thus, while the detection point 215′ is designated as different from the contact points 215, it may be the exact same physical structure as the contact points 215. Thus, in this example, the detection point 215′ is designated as such simply because, when connected to the mobile device 100, the detection point 215′ corresponds to, or in this example, receives the detection point 125′.

Similarly, there may be a corresponding example, where the detection point 125′ is exactly the same as the remaining contact points 125 of the mobile device 100, while the detection point 215′ is different from the remaining contact points 215 of the battery 200. As described above, the detection point refers to the fact that the connection between the detection point and the corresponding contact point on the other device will be disconnected prior to the remaining contact points. Thus, having a detection point on one of the devices (e.g., mobile device or battery) may be sufficient without having a detection point on the other one of the devices. However, throughout this description, the term detection point will be used to describe the contact point that corresponds to the actual detection point.

FIG. 4 shows a side view of the battery 200 of FIG. 3. The side view illustrates the battery jack 210, the corresponding points 215, and the corresponding detection point 215′. It should be noted that the location of the battery jack 210 on the illustrated side is only exemplary. Those skilled in the art will understand that the battery jack 210 may be located anywhere on a surface (e.g., bottom side, right side, left side, etc.) of the battery 200. It should also be noted that the location of the battery jack 210 on a midpoint of the illustrated side is only exemplary. Those skilled in the art will understand that the battery jack 210 may be located toward any end (e.g., top, bottom, right, left) on the surface of the side.

The battery jack 210 is the site where the battery connects to the battery port 120 of the mobile device 100. The corresponding points 215 provide the corresponding electrical connection with the contact points 125 of the mobile device 100. The corresponding detection point 215′ provide the corresponding connection with the detection point 125′. The corresponding points 215 and the corresponding detection point 215′ may also be, for example, solid pins, spring pins, metallic panels, etc. If the contact points 125 and the detection point 125′ are different, the corresponding points 215 and the corresponding detection point 215′ may be consistently matched. Those skilled in the art will understand that when the contact points 125 of the mobile device 100 is, for example, solid pins, the corresponding points 215 of the battery 200 may be, for example, metallic panels or pin receiving slots. The same applies to the corresponding detection point 215′. The battery jack 210 may exhibit a corresponding frame to the frame of the battery port 120. As illustrated in FIG. 3, the battery jack 210 may be a solid with the corresponding points 215 on a surface of the solid. The solid is insertable in the recess of the battery port 120. As illustrated, the insertable solid of the battery jack 210 is even with the surface of the battery 200. However, it should be noted that the battery jack 210 may, for example, extend beyond or stay within the surface of the housing 205. The corresponding points 215 may also be even with, extend beyond, or stay within the surface of the solid of the battery port 210. The contact pints 215 and the corresponding detection point 215′ will by discussed in more detail below with reference to FIGS. 5-7.

FIG. 5 shows a cross sectional view of an assembly of the mobile device 100 of FIG. 1 with the battery 200 of FIG. 3. The cross sectional view is taken across the mobile device 100 and the battery 200 where the contact points 125, the detection point 125′, the corresponding points 215, and the corresponding detection point 215′ exist. The assembled view illustrates how the battery port 120 couples to the battery jack 210. In addition, the assembled view illustrates how the contact points 125 couple to the corresponding points 215 and the detection point 125′ couples to the corresponding detection point 215′. Specifically, battery port 120 and the battery jack 210 are located on respective parts of the mobile device 100 and the battery 200 so that when in an operable position, the battery port 120 aligns with the battery jack 210. Furthermore, the alignment facilitates the coupling for each of the contact points 125 with each of the corresponding points 215 and the detection point 125′ with the corresponding detection point 215′. It should be noted that the use of male contact points 125 and male detection point 125′ with female corresponding points 215 and female corresponding detection point 215′ is only exemplary. Those skilled in the art will understand that the battery port 120 of the mobile device 100 may have female contact points 125 and female detection point 125′ while the battery jack 210 of the battery 200 may have male corresponding points 215 and male corresponding detection point 215′.

FIG. 6 shows a perspective view of the contact points 125 on the mobile device 100 of FIG. 1. Specifically, the perspective view of FIG. 6 is an enlarged view of the contact points 125 and the detection point 125′ illustrated as part of the mobile device 100. The contact points 125 with the detection point 125′ are shown as a single row of spring loaded pins. However, the use of a single row of spring loaded pins is only exemplary. The contact points 125 may be in more than one row, be disposed in a perpendicular column, be disposed on an angle, etc. The detection point 125′ may be in a separate row, etc. It should again be noted that the contact points 125 and the detection point 125′ may also be, for example, solid pins, metallic plates, etc.

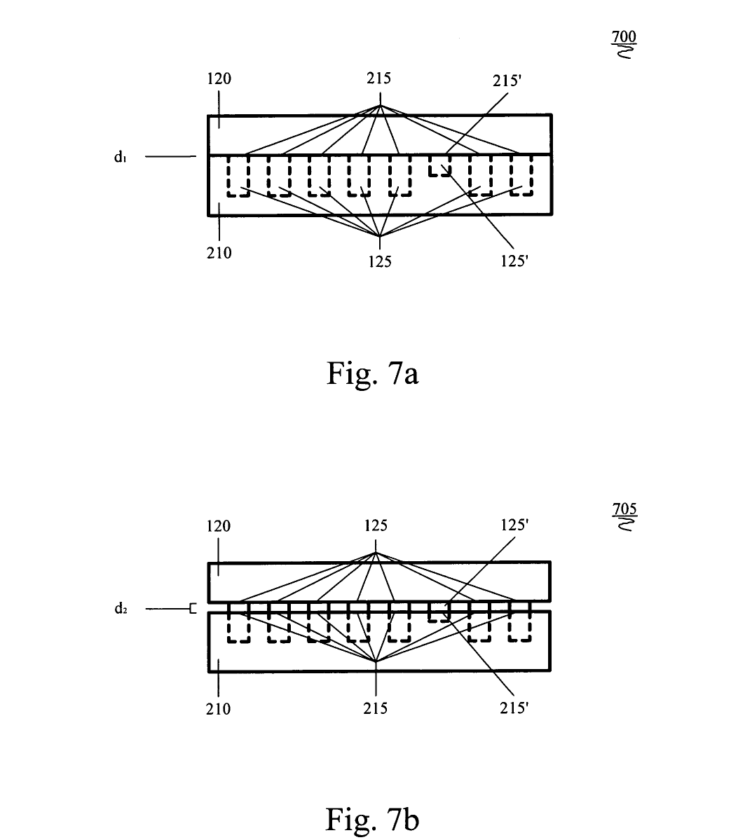

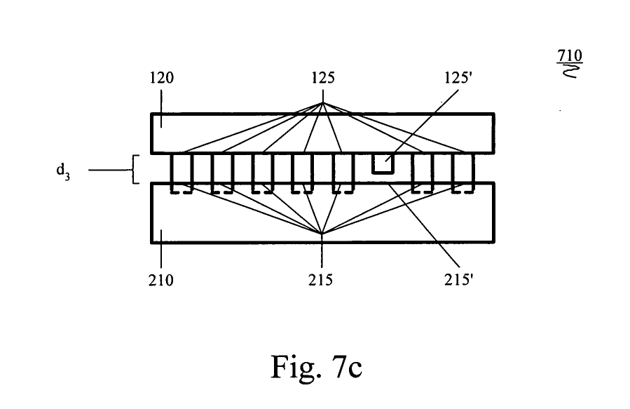

The exemplary embodiments of the present invention utilize a plurality of contact points 125 with a detection point 125′. The detection point 125′ provides sensory data to the mobile device 100 to alert the mobile device 100 when the battery is in a position to complete a connection. In the exemplary embodiment, the third pin (where the first pin is the leftmost) is the detection point 125′. If the contact points 125 are pins extending about 2 mm from the surface of the housing 105, the detection point 125′ may only extend about 1 to 1.5 mm. It should be noted that the use of the third pin and the use of a single detection point 125′ is only exemplary. The present invention may place the detection point 125′ in any of the contact point locations. In addition, the present invention may utilize more than one detection point 125′. It should also be noted that the contact points 125 may exhibit the same shape but also vary in length. The functionality of the detection point 125′ will be discussed in detail below with reference to FIGS. 7a-7d.

FIG. 7a shows a cross sectional view of a first connection 700 of the mobile device 100 of FIG. 1 with the battery 200 of FIG. 3. Specifically, the first connection 700 is at a time when the battery 200 is assembled with the mobile device 100. That is, the mobile device 100 is in a working mode (e.g., programs are running, processor is active, etc.) and drawing energy from the battery 200. The battery port 120 is coupled to the battery jack 210. The contact points 125 are illustrated as solid, male pins. The corresponding points 215 are illustrated as female pins. Every contact point 125 is connected to the corresponding points 215, thereby establishing the connection with the battery 200. The detection point 125′ is fully within the corresponding pin 215′. The first connection 700 illustrates a coupling where little to no distance exists between the battery port 120 and the battery jack 215. That is, the distance d₁ is substantially zero.

FIG. 7b shows a cross sectional view of a second connection 705 of the mobile device 100 of FIG. 1 with the battery 200 of FIG. 3. Specifically, the second connection 705 is at a time when the battery 200 is initially being removed from the mobile device 100. However, as illustrated, every contact point 125 is still connected to the corresponding points 215, thereby maintaining the established connection. The detection point 125′ is still connected by being partially within the corresponding pin 215′. The distance d₂ is greater than d₁ but less than the length of the detection point 125′ (i.e., detection point length>d₂>d₁).

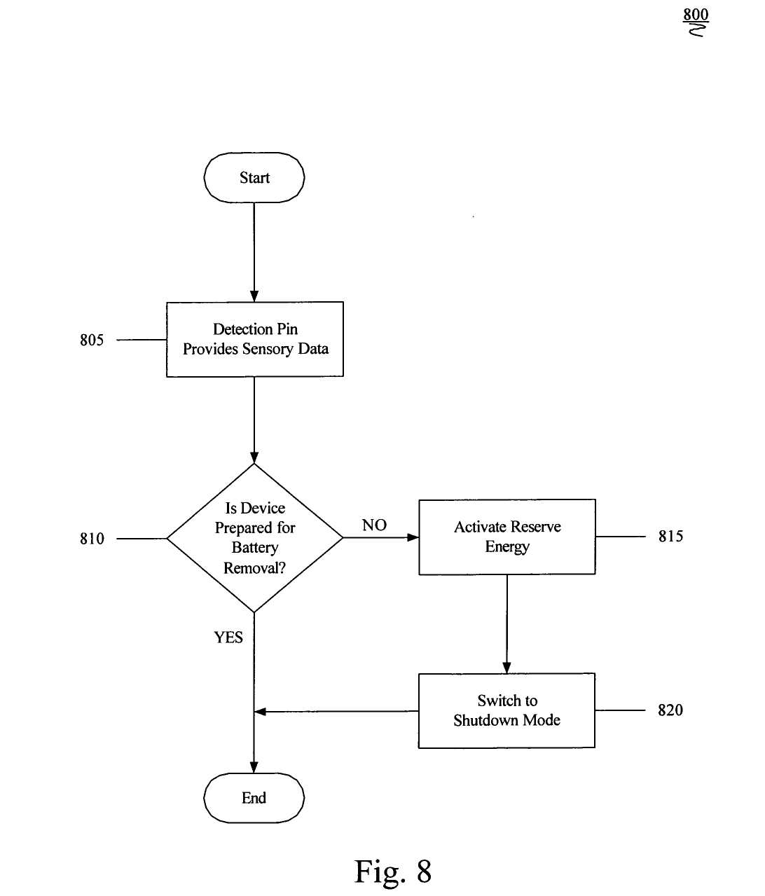

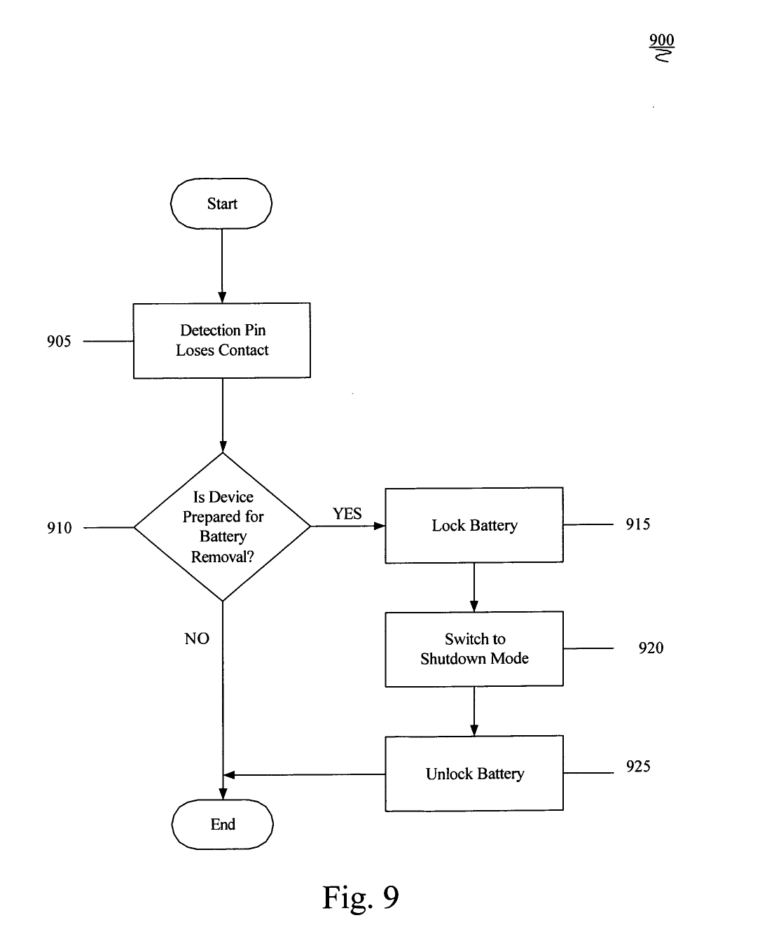

FIG. 7c shows a cross sectional view of a third connection 710 of the mobile device 100 of FIG. 1 with the battery 200 of FIG. 3. Specifically, the third connection 710 is at a time frame when the battery 200 still maintains the established connection, but is on the verge of losing the connection. That is, the mobile device may experience an abrupt gap in the power source. As discussed above, the gap may cause loss or corruption of data or some other adverse consequence. The detection point 125′ is no longer connected to the corresponding pin 215′. This disconnection provides the sensory data to the mobile device 100. The resulting sensory data alerts the mobile device 100 that the battery 200 may be on the verge of being disconnected. The mobile device 100 may take appropriate measures upon receiving this data. Exemplary appropriate measures will be discussed below with reference to methods of FIGS. 8-9. Thus, the distance d₃ is greater than d₁ and d₂. The distance d₃ is also greater than the length of the detection point 125′ (i.e., d₃>detection point length>d₂>d₁).

FIG. 8 shows a first method 800 of detecting battery removal according to an exemplary embodiment of the present invention. The first method 800 will be described with reference to the reference numerals described in detail above for FIGS. 1-7. As will be seen from the below description, the first method 800 takes place between the moment the battery 200 begins to be removed (i.e., connection still established) and the ultimate removal of the battery 200 (i.e., connection lost).

Prior to the start of the first method 800, it may be considered that a connection has been established between the battery 200 with the mobile device 100 and the mobile device 100 is operating normally. Optimally, the contact points 125 and the detection point 125′ are electrically connected to the corresponding points 215 and the corresponding detection point 215′, respectively. This was illustrated above with reference to FIG. 7a. At some point in time, the battery 200 begins to be removed from the mobile device 100. Specifically, the battery jack 210 starts to separate from the battery port 120, but the contact points 125 maintain the connection with the corresponding points 215. This was illustrated above with reference to FIG. 7b. However, since the detection point 125′ also remains connected to the corresponding detection point 215′, the mobile device 100 remains unaware that the battery is beginning to be removed.

In step 805, the detection point 125′ is no longer connected to the corresponding detection point 215′. However, the connection between the contact points 125 with the corresponding points 215 is maintained. That is, the battery 200 has been removed enough to go beyond the length of the detection point 125′ but not the length of the shortest of the contact points 125. The length of the detection point 125′ may be considered a threshold distance that represents the value to which the sensory data is compared (e.g., beyond the threshold distance causes activation, within threshold distance no activation). This was illustrated above with reference to FIG. 7c. Thus, in step 805, the detection point 125′ provides sensory data to the mobile device 100. Those skilled in the art will understand that the sensory data may be provided in any number of manners. For example, the processor of the mobile device 100 may monitor the conductivity of the detection point 125′. When the conductivity indicates that the detection point 125′ is open (e.g., no longer connected to the corresponding detection point 215′), this may indicate to the processor that the battery is in the process of being removed.

In another exemplary embodiment, the detection point 125′ may include a mechanical switch that changes states based on whether the detection point 125′ is connected to the corresponding detection point 215′. For example, the detection point 125′ may include a spring switch, wherein when it is compressed (e.g., connected to the corresponding detection point 215′) the switch is in a first state indicating a connection. In contrast, when it is fully extended (e.g., not connected to the corresponding detection point 215′), the switch is in a second state indicating no connection. Once again, the processor of the mobile device 100 may monitor the switch states to determine the connection status of the detection point 125′. Those skilled in the art will understand that there may be other manners of providing the sensory data to indicate that the connection has been lost.

Upon receiving the sensory data from the detection point 125′, in step 810, a determination is made whether the mobile device 100 is prepared for the removal of the battery 200. The mobile device 100 may have a specific state that it should be in prior to powering down, e.g., data saved in running programs, running programs shut down properly, etc. As part of step 810, the mobile device 100 may determine whether it is in this shut down mode or state.

If the determination dictates that the mobile device 100 is prepared for loss of power, then the first method 800 ends. Otherwise, the first method 800 continues to step 815 where a reserve energy supply is activated. As discussed above, a reserve energy supply such as super-cap may be present in the mobile device 100. The activation of the reserve energy supply will ensure that a continuous power supply is provided to the mobile device 100 until the mobile device 100 is prepared for the loss of power. Therefore, at this time, the battery 200 may have already been removed or it may still be connected.

Once the mobile device 100 has a continuous power supply, the method proceeds to step 820 where the mobile device 100 is prepared for the loss of power. For example, in step 825, the mobile device 100 is switched from a work mode to a shutdown mode. The shut down mode is designed so that currently programs that are running are closed properly (i.e., not prematurely shut down), input received until the switch is stored, etc. That is, the shutdown mode provides a condition where no loss or corruption of data occurs. Once the mobile device 100 is placed in a prepared condition, the first method 800 ends.

FIG. 9 shows a second method 900 of detecting battery removal according to an exemplary embodiment of the present invention. The second method 900 will also be described with reference to the reference numerals described in detail above for FIGS. 1-7. The second method 900 provides another means of preparing the mobile device 100 for the loss of the power supply. As discussed above, the mobile device 100 may not include a reserve power supply. Then, since a continuous power supply is necessary, it would be advantageous to continue using the battery 200. The steps 905-910 are identical with steps 805-810 described above with reference to FIG. 8.

Thus, skipping to step 915, a mechanism is activated to prevent the removal of the battery, thereby preventing the gap in power supply. Thus, unlike the subsequent time after step 815 of the first method 800, the battery 200 cannot be removed. For example, a locking mechanism may be activated to hold the battery 200 in a position where the contact points 125 are still connected to the corresponding points 215 (e.g., in a position similar to that illustrated in FIG. 7d). The locking mechanism may be any device that prevents the inadvertent or improper removal of the battery 200. For example, the locking mechanism may be a latch system, a solenoid, etc.

Once the battery 200 is prevented from being removed, the mobile device 100 maintains a continuous power supply since the connection between the contact points 125 with the corresponding points 215 are maintained. The second method 900 may then continue to step 920 where the mobile device 100 is placed in a condition that is prepared for battery removal. Similar to the actions taken in step 820 of the first method 800, step 920 may switch the mobile device 100 from a work mode to a shutdown mode. Once the mobile device has been prepared, the second method continues to step 925 where the battery 200 is unlocked and allowed to be removed.

It should be noted that the above described exemplary embodiments may incorporate various conventional features. As discussed above, the hardware and internal components of the mobile device 100 may conform and include the same hardware and internal components found in conventional mobile devices. In addition, other safety mechanisms may be included to further support the continuous power supply provided by the present invention. For example, conventional mobile devices have battery locks and latch systems. The mobile device 100 of the present invention may further incorporate these features. Failures of these safety mechanisms that cause an inadvertent or improper removal of the battery may be compensated by the present invention.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a plurality of contact points providing connectivity between the device and a further device;
a detection point providing connectivity between the device and the further device, wherein, as the further device is disconnected from the device, the detection point is disconnected prior to at least a portion of the plurality of contact points; and
a processor detecting the disconnection of the detection point and performing an action related to the detection of the disconnection.

2. The device of claim 1, wherein the device is a mobile computing device and the further device is a battery.

3. The device of claim 1, wherein the action is placing the device in a shutdown mode.

4. The device of claim 1, wherein the action is temporarily preventing the further device from being disconnected from the device.

5. The device of claim 1, wherein the plurality of contact points is one of solid male pins, spring male pins, metallic plates and female connectors.

6. The device of claim 5, wherein the detection point is shorter than the at least a portion of the contact points.

7. The device of claim 1, further comprising:
a back-up power supply disposed in the device, wherein the back-up power supply is activated when the detection point is disconnected.

8. A method, comprising:
detecting whether a detection point of a device has been disconnected from a further device, wherein the detection point disconnects prior to a connection point between the device and a further device;
determining whether the device is prepared for the disconnection of the further device; and
preparing the device for the disconnection.

9. The method of claim 8, wherein the preparing of the device includes placing the device in a shutdown mode.

10. The method of claim 8, wherein the preparing of the device includes activating a back-up power supply.

11. The method of claim 8, wherein the preparing the device includes locking a battery to prevent removal.

12. The method of claim 8, wherein the device is a mobile computing device and the further device is a battery.

13. The method of claim 8, wherein the contact point is one of a solid pin, a spring pin, a metallic plate and a female connector.

14. The method of claim 13, wherein the detection point is also the one of the solid pin, the spring pin, the metallic plate and the female connector as the contact point, wherein the detection point is shorter than the contact point.

15. A connector for a device, comprising:
a plurality of contact points configured to couple to corresponding further contact points of a further connector;
a detection point configured to couple to a corresponding detection point of a further connector, the detection point being configured to decouple from the corresponding detection point prior to at least a portion of the contact points decoupling from the corresponding further contact points.

16. The connector of claim 15, wherein the connector is included as part of one of a mobile computing device and a battery.

17. The connector of claim 15, wherein the coupling of the contact points to the further contact points provides an electrical connection.

18. The connector of claim 15, wherein the plurality of contact points and the detection point are male pins, the detection point male pin having a first length that is shorter than a second length of the at least a portion of the plurality of contact points.

19. The connector of claim 15, wherein the plurality of contact points are one of solid male pins, spring male pins, metallic plates and female connectors.

20. A device, comprising:
connection means for connecting the device to a further device;
sensing means for disconnecting from the further device prior to the connection means disconnecting from the further device; and
detection means for detecting the disconnection of the sensing means.
